(19) United States
(12) Patent Application Publication
(10) Pub. No.: US 2017/0016375 A1
(43) Pub. Date: Jan. 19, 2017

(54) HEATING AND HEAT-SHIELDED PIPING

(71) Applicant: NITTA CORPORATION, Osaka (JP)

(72) Inventors: Masatsugu Okada, Mie (JP); Kazuhiro Shimamura, Mie (JP)

(21) Appl. No.: 15/280,231

(22) Filed: Sep. 29, 2016

Related U.S. Application Data
(63) Continuation of application No. PCT/JP2015/056449, filed on Mar. 5, 2015.

(30) Foreign Application Priority Data
Apr. 2, 2014 (JP) 2014-076029

(51) Int. Cl. F01N 3/28; F16L 53/00

(52) U.S. Cl. CPC F01N 3/2896; F16L 53/00

(57) ABSTRACT

A heating and thermal insulation pipe including: a temperature-regulated pipe configured to allow a liquid to pass therethrough; at least two temperature-regulating pipes configured to allow a liquid coolant to pass therethrough, the at least two temperature-regulating pipes being in a mutual contact with the temperature-regulated pipe; a binding member for fixing the temperature-regulated pipe and the at least two temperature-regulating pipes together; and an outward protection tube sheathing therewith the temperature-regulated pipe and the at least two temperature-regulating pipes.

### CROSS REFERENCE TO RELATED APPLICATIONS

This is a continuation application of International Patent Application No. PCT/JP2015/056449, filed Mar. 5, 2015, claiming priority upon Japanese Patent Application No. 2014-076029, filed Apr. 2, 2014, of which full contents are incorporated herein by reference.

### BACKGROUND

Technical Field

The present invention, as embodiments, relates to a heating and thermal insulation pipe used for a urea water supply pipe in particular.

Description of the Related Art

In an internal combustion engine such as a diesel engine, a urea water supply pipe has been used in an exhaust gas purification system configured to purify nitrogen oxides (hereinafter, referred to as “NOx”). For such a system, the exhaust gas purification system including a catalyst arranged in an exhaust path of the internal combustion engine and a urea-water-addition valve arranged upstream from the catalyst has been known. The system has been configured such that the urea water stored within a tank is pumped up and pressurized by a pump so as to be fed through the urea water supply pipe to the urea-water-addition valve, and is added from the urea-water-addition valve into the exhaust path. In such a manner, the urea water has been decomposed into ammonia, and NOx in the exhaust gas has been selectively reduced by the ammonia on the catalyst, and as a result, the exhaust gas has been purified.

The urea water has the property of being frozen at substantially −11° C., and therefore, there has been a problem that, if an outside air temperature is low when a diesel engine is caused to stop, the urea water within the urea water supply pipe is frozen and cannot be supplied into the exhaust path when the diesel engine is caused to operate. In order to solve such a problem, a method of heating the urea water supply pipe with a heater to thaw the frozen urea water has been known (see, e.g., Patent Document 1).

There has been a problem that, when the diesel engine is caused to operate, an ambient temperature in the vicinity of a muffler in a vehicle is raised, and the urea water is also raised in temperature beyond the allowable level prior to being added through the urea-water-addition valve. When the temperature of the urea water is raised beyond the allowable level, there are some probabilities that the fraction of water is evaporated and the urea concentration is excessively increased, and ammonia is generated. A heat insulator is wrapped around the pipe so as to thermally insulate the pipe; nevertheless, if the entire pipe is arranged within an engine room or the like when the ambient temperature is high, the temperature rise cannot be sufficiently reduced.

There has been proposed, therefore, a technology of a cooling device arranged between a urea-water-addition valve for addition of a urea water and a urea water tank (see, e.g., Patent Document 2).

### Prior Art Documents

(Patent Documents)

Patent Document 1: Japanese Patent Application Publication No. 2005-214403

Patent Document 2: Japanese Patent Application Publication No. 2008-303786

### Problems to Be Solved

In order to solve the above problems, the objective of the present invention is to provide a heating and thermal insulation pipe serving as a urea water supply pipe in an exhaust gas purification system in a vehicle, the pipe simplified as well as unlikely to malfunction, the pipe capable of easily raising the temperature of a frozen urea water so as to thaw it if an outside air temperature is low and a urea water within the pipe is frozen when an engine is caused to stop, and capable of thermally insulating the urea water from an ambient temperature if the ambient temperature is high and there is a probability that the temperature of the urea water is raised beyond the allowable level when the engine is caused to operate.

### BRIEF SUMMARY

### Means for Solving Problems

In order to achieve the above objectives, a heating and thermal insulation pipe as embodiments of the present invention including: a temperature-regulated pipe configured to allow a liquid to pass therethrough; at least two temperature-regulating pipes configured to allow a liquid coolant to pass therethrough, the at least two temperature-regulating pipes being in a mutual contact with the temperature-regulated pipe; a binding member for fixing the temperature-regulated pipe and the at least two temperature-regulating pipes together; and an outward protection tube sheathing therewith the temperature-regulated pipe and the at least two temperature-regulating pipes.

### Advantageous Effects of the Invention

According to the heating and thermal insulation pipe as embodiments of the present invention, heating and thermal insulation can be performed without the use of any electrical heating means such as a heater and a cooler in the urea water supply pipe, thereby capable of providing a mechanism simplified and unlikely to malfunction.

### BRIEF DESCRIPTION OF THE SEVERAL VIEWS OF THE DRAWINGS

For more thorough understanding of the present invention and advantages thereof, the following descriptions should be read in conjunction with the accompanying drawings, in which:

FIG. 1 depicts a structural view of an exhaust gas purification device applied with a pipe according to the present invention;

FIG. 2A depicts a structural view of an embodiment of the present invention;

FIG. 2B depicts a perspective view of the structural aspect of an embodiment of the present invention;

FIG. 3 depicts a schematic view of a flow example of urea water and LLC of the present invention;

FIG. 4 depicts a schematic view of a thermal insulation performance confirmation test device;

FIG. 5A depicts a schematic view showing a flow of urea water and LLC of example 1 of the present invention;

FIG. 5B depicts a schematic view showing a flow of urea water and LLC of example 2 of the present invention;

FIG. 5C depicts a schematic view showing a flow of urea water and LLC of example 3 of the present invention;

FIG. 5D depicts a schematic view showing a flow of urea water and LLC of example 4 of the present invention;

FIG. 5E depicts a schematic view showing a flow of urea water and LLC of comparative example 1 with respect to the present invention;

FIG. 5F depicts a schematic view showing a flow of urea water of comparative example 2 with respect to the present invention;

FIG. 5G depicts a schematic view showing a flow of urea water and bifurcated LLC as a modified example of example 1 of the present invention;

FIG. 5H depicts a schematic view showing a flow of urea water and trifurcated LLC as a modified example of example 1 of the present invention;

FIG. 6 depicts a schematic view of a thawing performance confirmation test;

FIG. 7A depicts a structural view of examples 3, 4 of the present invention;

FIG. 7B depicts a structural view of examples 1, 5 of the present invention; and

FIG. 7C depicts a structural view of example 6 of the present invention.

### DETAILED DESCRIPTION

Hereinafter, a method of thawing frozen urea water in an embodiment of the present invention will be described by showing, e.g., a method of thawing a urea water supply pipe (hereinafter, referred to as a “urea water pipe”) with the aid of heat conduction of a flow pipe (hereinafter, referred to as an “LLC pipe”) configured to allow a long life coolant (hereinafter, referred to as an “LLC”) serving as a cooling liquid of an engine to pass therethrough. The temperature of the LLC pipe is high enough to thaw the frozen urea water, and therefore, the LLC pipe and the urea water pipe are arranged in such a manner that they are in a mutual contact with each other, thereby capable of thawing the urea water caused by virtue of the heat conduction to be frozen. The temperature of the LLC pipe is low enough to prevent the temperature of the urea water from being raised up to the allowable level, and therefore, by arranging appropriately the LLC pipe and the urea water pipe, thereby capable of attaining both the objectives of thawing and thermal insulation.

### (Embodiments)

Hereinafter, a heating and thermal insulation pipe as an embodiment of the present invention will be described with reference to the accompanying drawings.

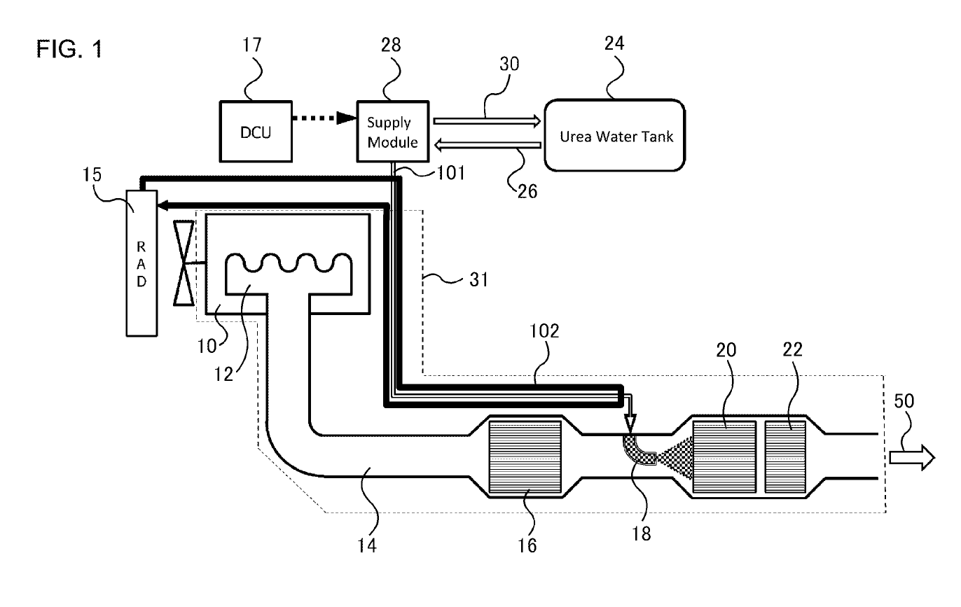

FIG. 1 depicts a view of an exhaust gas purification device, as an embodiment configured to purify nitrogen oxides (NOx) contained in an engine exhaust gas through a catalytic reduction reaction, applied with urea water used as a reducing agent.

In an exhaust pipe 14 connected to an exhaust manifold 12 of an engine 10, an oxidation catalyst 16 for oxidizing nitrogen monoxide (NO) to nitrogen dioxide (NO₂), an injection nozzle 18 controlled by a dosing control unit (DCU) 17 to inject and supply a necessary amount of urea water corresponding to the operation status of the engine 10, an NOx reduction catalyst 20 for reducing and purifying NOx with ammonia obtained by hydrolyzing the urea water injected from the injection nozzle 18, and an ammonia oxidation catalyst 22 for oxidizing the ammonia passing through the NOx reduction catalyst 20 are arranged along an exhaust-gas-flow direction indicated by an arrow 50.

Furthermore, the urea water stored in a storage tank 24 is allowed to pass through a first urea water pipe 26, a reducing agent supply device 28, and a second urea water pipe 101 so as to be sprayed through the injection nozzle 18. On the other hand, an extra amount of urea water supplied to the reducing agent supply device 28 is allowed to pass through a third urea water pipe 30 and return to the storage tank 24. A radiator 15 is configured to cool the LLC (liquid coolant for engine) circulated through an LLC pipe 102. A part of the LLC pipe 102 is arranged so as to make a mutual contact with the outside of the second urea water pipe 101. In FIG. 1, an area enclosed by dotted lines 31 is a region whose temperature is raised to a high temperature when the engine is caused to operate, and the second urea water pipe 101 present therewithin is subjected to the high temperature.

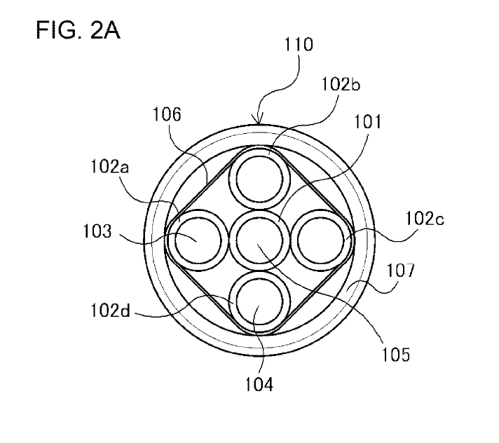

FIGS. 2A, 2B depict a structural view of the heating and thermal insulation pipe as an embodiment of the present invention. FIG. 2A depicts a cross-sectional view seen in a direction of an arrow in FIG. 2B, and FIG. 2B depicts a perspective view of the heating and thermal insulation pipe.

A pipe 110 includes the urea water pipe 101, the LLC pipes 102 represented by numerals 102a to 102d, a binding member 106, and an outward protection tube 107. More specifically, the urea water pipe 101 is arranged at a center of the pipe 110, and the four LLC pipes 102 are arranged in such a manner that the urea water pipe 101 is in a mutual contact with the four LLC pipes 102 as surroundings of the urea water pipe 101 in a horizontal direction with respect to an axis of the urea water pipe 101 and in a vertical direction with respect to the center. The urea water pipe 101 at the center and the four LLC pipes 102 as the surroundings are bound with the binding member 106 in such a manner that the urea water pipe 101 and the four LLC pipes 102 are not separated from each other. The outward protection tube 107 is arranged so as to surround the urea water pipe 101, the four LLC pipes 102, and the binding member 106 in order to achieve the protection from external damage and the heat retention.

In FIG. 2B, for ease of seeing, the binding member 106 and the outward protection tube 107 are shown such that their lengths are shorter than the actual lengths. The LLC pipes 102 represented by numerals 102a to 102d are arranged so as to make U-turns (be folded back) three times and return, and the LLC enters through an entrance 103 and exits through an exit 104. The urea water enters through the entrance 105 into the urea water pipe 101. The urea water pipe 101 and the LLC pipes 102 are tubes made of nylon and/or fluorine resin or the like having heat resistance and flexibility. The binding member 106 preferably binds the urea water pipe 101 and the LLC pipes 102 in such a manner that the entire lengths of them are covered fully with the binding member 106, or that they may be wound around by the binding member 106 as a ribbon-shaped material, and their material is preferably nylon, polypropylene, polyethylene terephthalate, or the like. The outward protection tube 107 needs to have flexibility, and preferably, a shape thereof is corrugated and material thereof is nylon, polypropylene, or the like. The material used for the urea water pipe 101, the LLC pipes 102, the binding member 106, and the outward protection tube 107 may be individually determined according to the conditions of the use of the pipe 110.

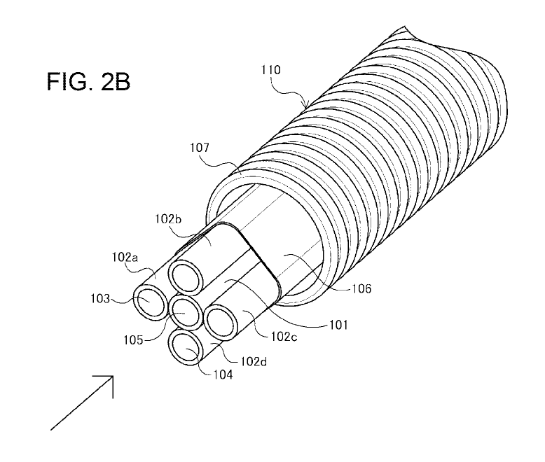

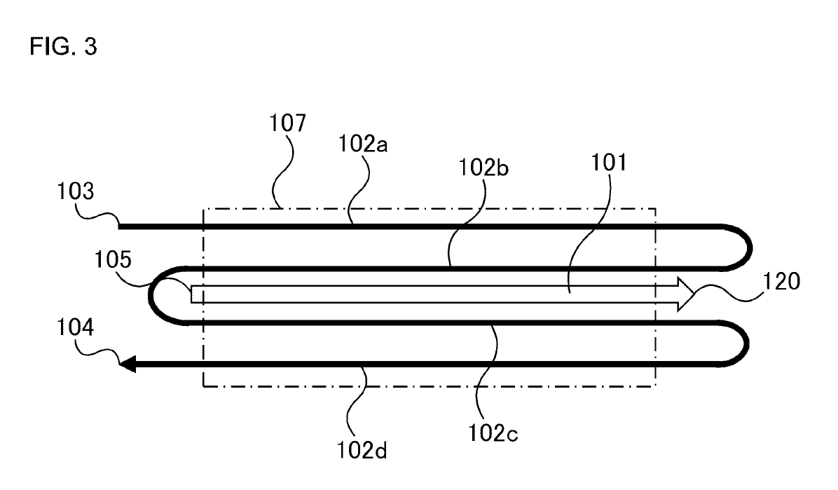

FIG. 3 depicts a schematic view of the urea water pipe and the LLC pipes as embodiments. The urea water pipe 101 is represented by a white-colored arrow and the LLC pipes 102 are represented by a black-colored arrow, each of which arrows is indicative of a flow of fluid. The outward protection tube 107 is represented by alternative long and short dashed lines while the binding member is omitted. It is shown in FIG. 3 that the urea water enters through the entrance 105 into the urea water pipe 101 and exits through the exit 120 from the urea water pipe 101. Regarding a path of the LLC allowed to enter through the entrance 103, the LLC pipe 102a makes a mutual contact with the urea water pipe 101 and makes a U-turn (to be folded back) to the LLC pipe 102b when being temporarily separated from the interior of the outward protection tube 107 (outside the outward protection tube), and thereafter, the LLC pipe 102b makes a mutual contact with the urea water pipe 101 again and makes a U-turn to the LLC pipe 102c when being temporarily separated again from the interior of the outward protection tube 107, and thereafter, the LLC pipe 102c makes a mutual contact with the urea water pipe 101 again and makes a U-turn to the LLC pipe 102d when being separated again from the interior of the outward protection tube 107, and thereafter, the LLC pipe 102d makes the fourth-time mutual contact with the urea water pipe 101, and the LLC is allowed to exit through the exit 104.

The thawing of the urea water frozen within the urea water pipe 101 is performed by raising the temperature of the frozen urea water through heat conduction resulting from a mutual contact with the LLC pipes 102 whose temperature is higher than the freezing temperature of −11° C. in the urea water.

In FIG. 1, heat conduction from an ambient atmosphere in the vicinity of the exhaust pipe 14 to the second urea water pipe 101 is also realized by arranging, around the second urea water pipe 101, the LLC pipes 102 whose temperature is lower than the ambient temperature. In such a manner, heat within the dotted lines 31 shown in FIG. 1 is used for raising the temperature of the LLC within the LLC pipes 102, and therefore, the temperature rise of the urea water allowed to pass through the second urea water pipe 101 is reduced.

### (Thermal Insulation Performance Confirmation Test)

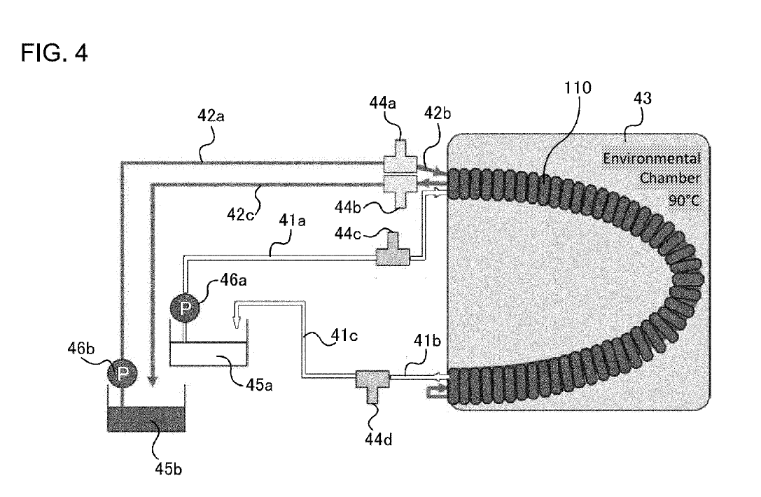

FIG. 4 depicts a schematic view of a device for confirmation test of the thermal insulation performance.

The test device includes an environmental chamber 43 whose internal temperature is maintained at 90° C., the pipe 110 in an embodiment described above, pipes (hereinafter, referred to as “temperature-regulated pipes”) 41a, 41b, 41c whose temperatures are regulated, pipes (hereinafter, referred to as “temperature-regulating pipes”) 42a, 42b, 42c for performing temperature regulation, temperature detection units 44a, 44b, 44c, 44d, temperature regulation function-equipped tanks 45a, 45b, and pumps 46a, 46b.

A liquid (water) in the temperature regulation function-equipped tank 45a is pumped up by the pump 46a so as to pass through the temperature-regulated pipe 41a and the temperature detection unit 44c at the entrance, and is caused to pass through the interior of the pipe 110 arranged in the environmental chamber 43 maintained at 90° C., and is further caused to enter into the temperature-regulated pipe 41b so as to pass through the temperature detection unit 44d at the entrance and the temperature-regulated pipe 41c, and is still further caused to return to the temperature regulation function-equipped tank 45a. The water with a flow rate at 17 mL/min and a temperature at 50° C. is caused to pass through the temperature-regulated pipe 41a.

A liquid coolant (water) in the temperature regulation function-equipped tank 45b is pumped up by the pump 46b so as to pass through the temperature-regulating pipe 42a, the temperature detection unit 44a at the entrance, and the temperature-regulating pipe 42b, and is caused to make a plurality of times U-turns inside the pipe 110 arranged in the environmental chamber 43 maintained at 90° C., and is further caused to pass through the temperature detection unit 44b at the exit and the temperature-regulating pipe 42c, and is still further caused to return to the temperature regulation function-equipped tank 45b. The liquid coolant (water) with a flow rate at 3 mL/min and a temperature at 50° C. is caused to pass through the temperature-regulating pipe 42a.

The entrance temperature and the exit temperature of the temperature-regulating pipe 42b are detected by the temperature detection units 44a, 44b, and the raised temperature of the liquid coolant (water) passing through the temperature-regulating pipe 42b is calculated by subtracting the entrance temperature from the exit temperature.

The results of the test are shown in TABLE 1. It has been found that the difference of the raised temperature of the liquid (water) within the temperature-regulated pipe decreases with increase in the number of temperature-regulating pipes in a mutual contact with the temperature-regulated pipe. In other words, the raised temperature is reduced and the thermal insulation effect is enhanced with increase in the number of temperature-regulating pipes as well as decrease in the entrance temperature of the fluid in the temperature-regulating pipe.

When comparing the test results between: the temperature-regulating pipe brought into a mutual contact with the temperature-regulated pipe and thereafter extended out of the outward protection tube so as to be U-turned (folded back) and brought into a mutual contact with the temperature-regulated pipe again (hereinafter, referred to as a “U-turn pipe”); and the temperature-regulating pipe brought into a mutual contact with the temperature-regulated pipe and thereafter extended out of the outward protection tube so as not to return (hereinafter, referred to as a “one-way pipe”), on condition that the temperature-regulating pipes in contact is equal in the number to each other, it has been found in TABLE 1 that the difference of the raised temperature of the liquid (water) in the temperature-regulated pipe is smaller in the one-way pipe than in the U-turn pipe. It has been considered that the temperature of the liquid coolant (water) in the temperature-regulating pipe returning in the U-turn pipe is higher than the temperature of the water at the entrance of the one-way pipe, and therefore, the thermal insulation effect is reduced.

TABLE 1

| | The number of | Difference of raised temperature |
|---|---|---|
| | pieces of | in temperature regulated pipe |
| | temperature | Results of subtracting “Entrance” |
| Examples | regulating pipes | from “Exit” in Temperature [° C.] |
| 1 | 4 (U-turn pipe) | 2.2 |
| 2 | 4 (one-way pipe) | 1.0 |
| 3 | 2 (U-turn pipe) | 3.6 |
| 4 | 2 (one-way pipe) | 3.3 |
| Comparative 1 | 1 (one-way pipe) | 6.7 |
| Comparative 2 | 0 (no temperature | 15.1 |
| | regulating pipe) | |

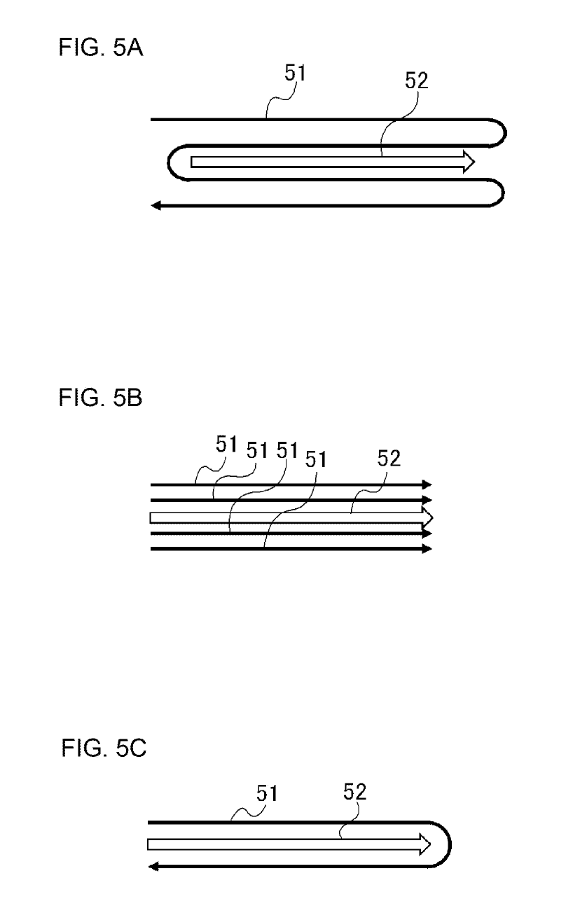

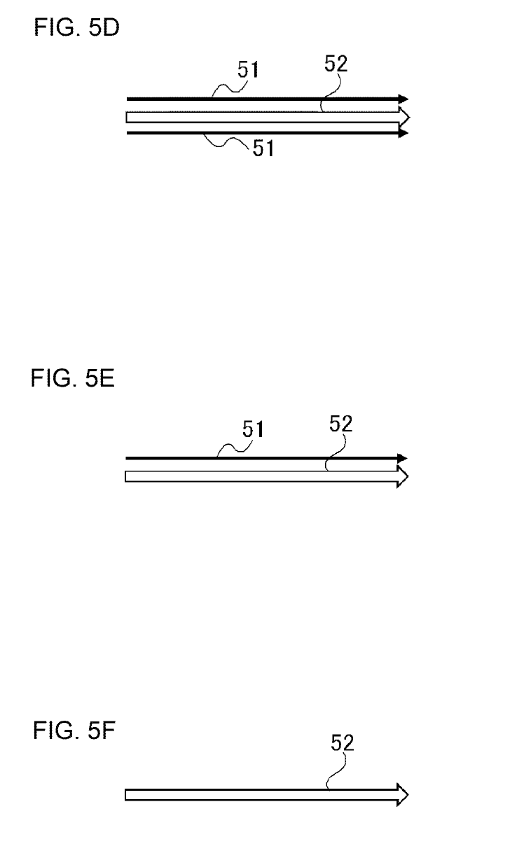

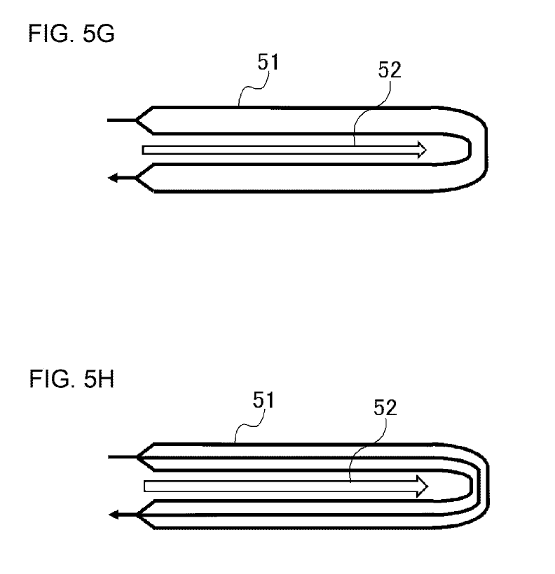

FIG. 5A depicts a schematic view showing example 1 in TABLE 1 (the same as FIG. 3), and also depicts a view showing a flow of the liquid in the pipes arranged such that a temperature-regulated pipe 52 makes three-times U-turns around a temperature-regulating pipe 51 while making a mutual contact with the temperature-regulating pipe 51, and the temperature-regulating pipe 51 makes a mutual contact with the temperature-regulated pipe 52 four times.

FIG. 5B depicts a schematic view showing example 2 in TABLE 1, and also depicts a view showing a flow of the liquid in the pipes arranged such that four temperature-regulating pipes 51 are brought, one way, into a contact with the surrounding of a temperature-regulated pipe 52.

FIG. 5C depicts a schematic view showing example 3 in TABLE 1, and also depicts a view showing a flow of the liquid in the pipes arranged such that a temperature-regulating pipe 51 makes one U-turn around a temperature-regulated pipe 52 while making a mutual contact with the temperature-regulated pipe 52, and the temperature-regulating pipe 51 makes a mutual contact with the temperature-regulated pipe 52 two times.

FIG. 5D depicts a schematic view showing example 4 in TABLE 1, and also depicts a view showing a flow of the liquid in the pipes arranged such that two temperature-regulating pipes 51 are brought, one way, into a contact with the surrounding of a temperature-regulated pipe 52.

FIG. 5E depicts a schematic view showing comparative example 1 in TABLE 1, and also depicts a view showing a flow of the liquid in the pipes arranged such that one temperature-regulating pipe 51 is brought, one way, into a contact with the surrounding of a temperature-regulated pipe 52.

FIG. 5F depicts a schematic view showing comparative example 2 in TABLE 1, and also depicts a view showing a flow of the liquid in only one temperature-regulated pipe 52 without any temperature-regulating pipe 51.

As a modified example of example 1, the temperature-regulating pipe 51 may be branched into a plurality of portions in front of the entrance, and the branched portions are individually U-turned once and are combined together once again into one pipe at the exit. For example, FIG. 5G depicts a view in which the temperature-regulating pipe 51 is bifurcated, and FIG. 5H depicts a view in which the temperature-regulating pipe 51 is trifurcated.

### (Thawing Performance Confirmation Test)

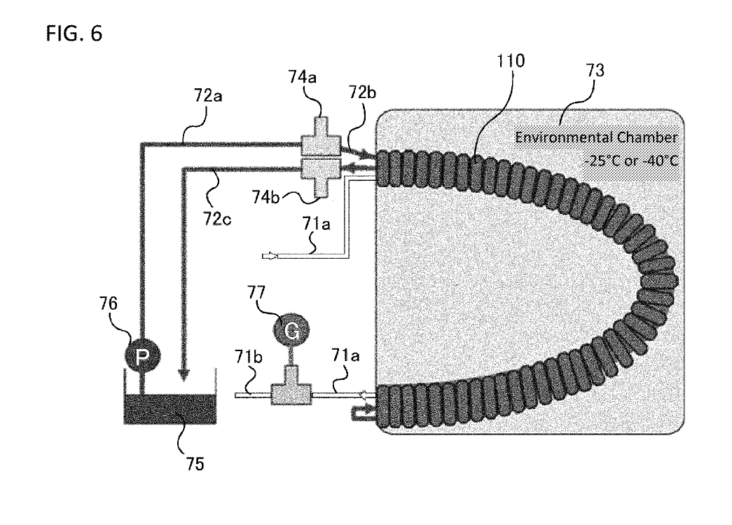

FIG. 6 depicts a schematic view of a device for confirmation test of the thawing performance in examples.

The test device includes an environmental chamber 73 whose internal temperature is maintained at −25° C. or −40° C., the pipe 110 in an embodiment described above, temperature-regulated pipes 71a, 71b, temperature-regulating pipes 72a, 72b, 72c, temperature detection units 74a, 74b, a temperature regulation function-equipped tank 75, a pump 76, and a pressure meter 77.

Water in the temperature regulation function-equipped tank 75 is pumped up by the pump 76 so as to pass through the temperature-regulating pipe 72a and the temperature detection unit 74a at the entrance and contact an inside of the temperature-regulated pipe 71a in the pipe 110 arranged within the environmental chamber 73, and is caused to reach the exit, and thereafter, the water is caused to make a U-turn and contact, again, an inside of the temperature-regulated pipe 71a within the environmental chamber 73, and is further caused to pass through the temperature detection unit 74b and the temperature-regulating pipe 72c, and is still further caused to return to the temperature regulation function-equipped tank 75.

Completely frozen urea water is sealed in the temperature-regulated pipe 71a. The LLC is caused to pass through the temperature-regulating pipes 72a, 72b at a temperature of 30° C. at a flow rate of 3 L/min. A period of time until the pressure of the temperature-regulated pipe 71a is varied after the start of the flowing of the LLC is measured by the pressure meter 77, and is defined as the thawing time of the urea water. The test was performed in examples 5, 6.

The results of the measurement are shown in TABLE 2, and it has been confirmed that even in example 5 where the thawing performance is low, the urea water is thawed in less than 3 minutes and that necessary and sufficient performance is achieved. Example 5 is shown in a schematic view in FIG. 5C described above, and Example 6 is shown in a schematic view in FIG. 5H described above.

TABLE 2

| | | Urea water thawing time [s] | |
|---|---|---|---|
| | The number of | Environmental | |
| | pieces of | chamber | |
| | temperature | temperature | Environmental chamber |
| Examples | regulating pipes | at −25° C. | temperature at −40° C. |
| 5 | 2 (U-turn) | 100 | 160 |
| 6 | 6 (U-turn after | 73 | 90 |
| | combining 3 | | |
| | pieces) | | |

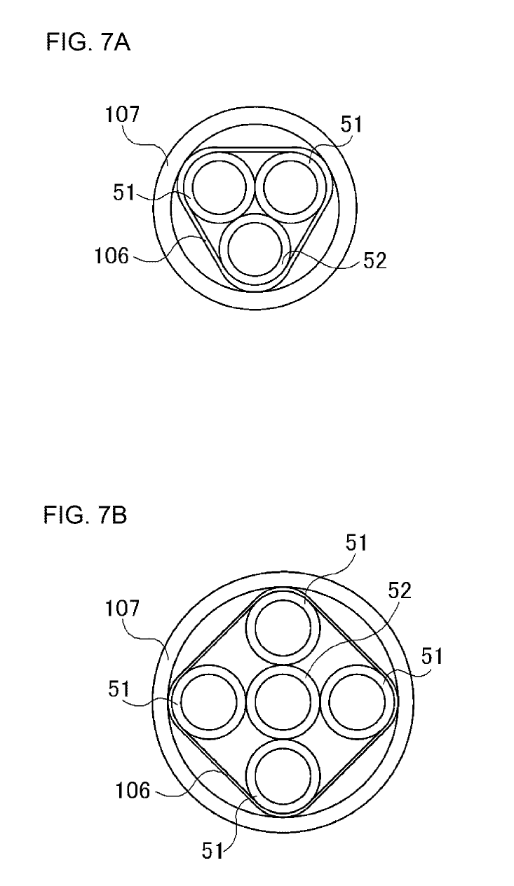

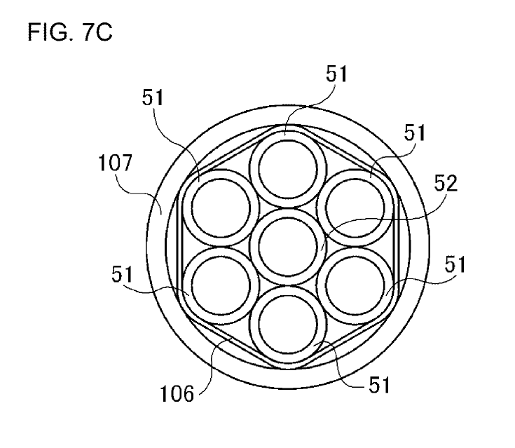

FIGS. 7A, 7B, 7C are views of the pipes of examples 1 to 6 seen in the same direction as indicated by the arrow of FIG. 2B.

FIG. 7A (cross-sectional view of the pipe of FIGS. 5C, 5D) depicts a view of examples 3, 4 each including two temperature-regulating pipes 51 in a mutual contact with the temperature-regulated pipe 52 bound with the binding member 106 and surrounded by the outward protection tube 107. The flow of the LLC and the urea water is as shown in FIGS. 5C, 5D. FIG. 7B (cross-sectional view of the pipe of FIGS. 5A, 5G) depicts a view of examples 1, 5, and shows the structures shown in FIGS. 2A, 2B. The flow of the LLC and the urea water is as shown in FIGS. 5A, 5G. FIG. 7C (cross-sectional view of the pipe of FIG. 5H) depicts a view of example 6 including six temperature-regulating pipes 51 in a mutual contact with the temperature-regulated pipe 52, in six directions with respect to an axis of the temperature-regulated pipe 52 at the center, bound with the binding member 106 and surrounded by the outward protection tube 107. The flow of the LLC and the urea water is as shown in FIG. 5H.

It has been found from the results of the two tests described above that the thermal insulation effect is enhanced with increase in the number of temperature-regulating pipes 52, and that the raised temperature inhibition is reduced and the thawing time is reduced, that is, the heating effect is enhanced.

Embodiments are described with respect to the present invention; however, these embodiments are illustrative and are not intended to limit any scope of the present invention. These novel embodiments can be practiced in various other forms, and various omissions, replacements, and modifications are possible without deviating from the scope of the spirit of the present invention. Variations of these embodiments are included in the scope and spirit of the described inventions, and are included in a scope equivalent to the inventions described in scope of the claims.

### REFERENCE NUMERALS

101 urea water pipe
102 (102a-102d) LLC pipe
106 binding member
107 outward protection tube
110 pipe in example
43 environmental chamber
51 temperature-regulating pipe
52 temperature-regulated pipe
73 environmental chamber

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A heating and thermal insulation pipe comprising:
a temperature-regulated pipe configured to allow a liquid to pass therethrough;
at least two temperature-regulating pipes configured to allow a liquid coolant to pass therethrough, the at least two temperature-regulating pipes being in a mutual contact with the temperature-regulated pipe;
a binding member for fixing the temperature-regulated pipe and the at least two temperature-regulating pipes together; and
an outward protection tube sheathing therewith the temperature-regulated pipe and the at least two temperature-regulating pipes.

2. The heating and thermal insulation pipe according to claim 1, wherein through the mutual contact with the at least two temperature-regulating pipes,
the temperature-regulated pipe is heated when an ambient temperature of the temperature-regulated pipe and the at least two temperature-regulating pipes is low, and
heating of the temperature-regulated pipe is reduced when the ambient temperature is high.

3. The heating and thermal insulation pipe according to claim 2, wherein the at least two temperature-regulating pipes each is a liquid coolant pipe for an internal combustion engine.

4. The heating and thermal insulation pipe according to claim 2, wherein the liquid of the temperature-regulated pipe is urea water.

5. The heating and thermal insulation pipe according to claim 2, wherein the outward protection tube is a corrugated tube.

6. The heating and thermal insulation pipe according to claim 2, wherein the at least two temperature-regulating pipes are arranged in such a manner that the at least two temperature-regulating pipes are folded back outside the outward protection tube.

7. The heating and thermal insulation pipe according to claim 2, wherein the at least two temperature-regulating pipes are even in number.

8. The heating and thermal insulation pipe according to claim 3, wherein the liquid of the temperature-regulated pipe is urea water.

9. The heating and thermal insulation pipe according to claim 3, wherein the outward protection tube is a corrugated tube.

10. The heating and thermal insulation pipe according to claim 3, wherein the at least two temperature-regulating pipes are even in number.

11. The heating and thermal insulation pipe according to claim 4, wherein the outward protection tube is a corrugated tube.

12. The heating and thermal insulation pipe according to claim 4, wherein the at least two temperature-regulating pipes are arranged in such a manner that the at least two temperature-regulating pipes are folded back outside the outward protection tube.

13. The heating and thermal insulation pipe according to claim 4, wherein the at least two temperature-regulating pipes are even in number.

14. The heating and thermal insulation pipe according to claim 5, wherein the at least two temperature-regulating pipes are even in number.

15. The heating and thermal insulation pipe according to claim 8, wherein the outward protection tube is a corrugated tube.

16. The heating and thermal insulation pipe according to claim 8, wherein the at least two temperature-regulating pipes are even in number.

17. The heating and thermal insulation pipe according to claim 15, wherein the at least two temperature-regulating pipes are arranged in such a manner that the at least two temperature-regulating pipes are folded back outside the outward protection tube.

18. The heating and thermal insulation pipe according to claim 17, wherein the at least two temperature-regulating pipes are even in number.

19. The heating and thermal insulation pipe according to claim 17, wherein the temperature-regulated pipe is arranged at a center, and four temperature-regulating pipes are arranged in such a manner that the temperature-regulated pipe is in a mutual contact with the four temperature-regulating pipes as surroundings thereof in a horizontal direction with respect to an axis thereof and in a vertical direction with respect to the center.

20. The heating and thermal insulation pipe according to claim 17, wherein the temperature-regulated pipe is arranged at a center, and six temperature-regulating pipes are arranged in such a manner that the temperature-regulated pipe is in a mutual contact with the six temperature-regulating pipes as surroundings thereof in six directions with respect to an axis thereof at the center.
